(19) United States
(12) Patent Application Publication
(10) Pub. No.: US 2021/0150650 A1
(43) Pub. Date: May 20, 2021

(54) RENTAL PROPERTY MANAGEMENT SYSTEM

(71) Applicant: Christopher Arnold, Santa Rosa Beach, FL (US)

(72) Inventor: Christopher Arnold, Santa Rosa Beach, FL (US)

(21) Appl. No.: 16/784,959

(22) Filed: Feb. 7, 2020

Related U.S. Application Data
(60) Provisional application No. 62/935,703, filed on Nov. 15, 2019.

(51) Int. Cl. G06Q 50/16; G06Q 30/06; G06Q 10/10; G06Q 20/14

(52) U.S. Cl. CPC G06Q 50/163; G06Q 20/14; G06Q 10/1093; G06Q 30/0645

(57) ABSTRACT

A system for managing a rental property comprising a computing device in operable communication with a database to store information related to a plurality of rental properties. A calendar module receives scheduling information via the computing device. The scheduling information corresponds to a plurality of rental properties and a plurality of housekeepers to organize the scheduling information on a status interface comprising a plurality of indicators to indicate the status of the plurality of housekeepers.

### CROSS-REFERENCE TO RELATED APPLICATIONS

The present application claims priority to U.S. Provisional Application No. 62/935,703 filed on Nov. 15, 2019, entitled “RENTAL PROPERTY MANAGEMENT SYSTEM” the entire disclosure of which is incorporated by reference herein.

### TECHNICAL FIELD

The embodiments generally relate to systems for property management and, more specifically, relate to the management of rental property housekeepers.

### BACKGROUND

Property management encompasses the operation, control, and oversight of real estate. This may include properties which are rented short-term, such as hotels and vacation properties, or properties managed long-term, such as private homes, condos, apartments, etc.

Short term rental properties often require routine cleaning by housekeeping personnel between tenants or at other predetermined time intervals (such as daily, weekly, etc.). In the current arts, the property manager(s) must contact housekeeping personnel individually to determine the status of the property each day.

Property managers are also responsible for managing maintenance personnel, tenants, rental availabilities, and for transmitting and receiving payments to various parties. In the current arts, property managers may use a variety of systems to manage each aspect of the rental property.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein relate to a system for managing a rental property, comprising a computing device in operable communication with a database to store information related to a plurality of rental properties. A calendar module receives scheduling information via the computing device. The scheduling information corresponds to a plurality of rental properties and a plurality of housekeepers and inspectors to organize the scheduling information on a status interface, comprising a plurality of indicators to indicate the status of the plurality of housekeepers and inspectors. The system allows for property managers to easily determine the status of a plurality of rental properties on a particular day.

In one aspect, a communication module permits the communication between one or more users.

In one aspect, an invoice module permits the generation and transmission of an invoice.

In one aspect, a ready interface indicates properties which are ready for rental during a period of time.

In one aspect, the communication module transmits check-in information corresponding to a rental property to the tenants.

In one aspect, a scheduling module facilitates scheduling of the plurality of housekeepers.

In one aspect, the plurality of indicators are color coded.

In one aspect, the system further comprises a payment processing system.

In one aspect, the system further comprises a maintenance personnel interface.

In one aspect, the system further comprises a communication module to permit communication between users and tenants.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a screenshot of the calendar interface, according to some embodiments;

FIG. 3 illustrates a block diagram of the operation functions, according to some embodiments;

FIG. 4 illustrates a screenshot of the ready interface, according to some embodiments;

FIG. 5 illustrates a block diagram of the server engine and associated modules, according to some embodiments; and

FIG. 6 illustrates a block diagram of the server engine and associated modules, according to some embodiments.

### DETAILED DESCRIPTION

The specific details of the single embodiment or variety of embodiments described herein are to the described system and methods of use. Any specific details of the embodiments are used for demonstrative purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” may refer to property managers, personnel, tenants, administrators, housekeepers, inspectors, or others in operable communication with the system to manage and otherwise interact with a rental property maintenance and services.

As used herein, the term “property” may comprise a rental property, business, leased property, or other property which may benefit from a property manager and/or property management software to monitor various tasks related to the property.

In general, the embodiments described herein provide systems and methods for managing a rental property and more specifically for managing housekeeping personnel for a plurality of properties. The system provides an interface provided on a computing device which allows the user to view the status of housekeepers, inspectors, or other personnel over a user-determined period of time (such as for a single day, hours of a day, minutes of an hour, or other time period) wherein each of the plurality of indicators is provided on a timeline corresponding to the date and the time of the service. The system also provides various features which simplify various property management processes including payment processing, invoice generation and transmittal, scheduling, etc. Further, the system may also provide a means for transmitting and receiving communications between the property manager, housekeepers, inspectors, maintenance personnel, tenants, and other persons associated with the rental property.

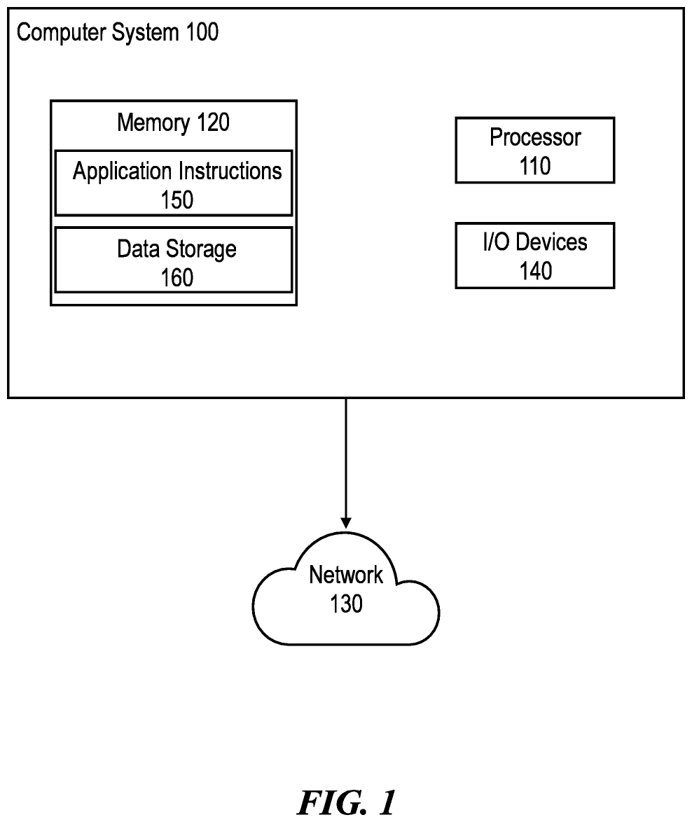

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

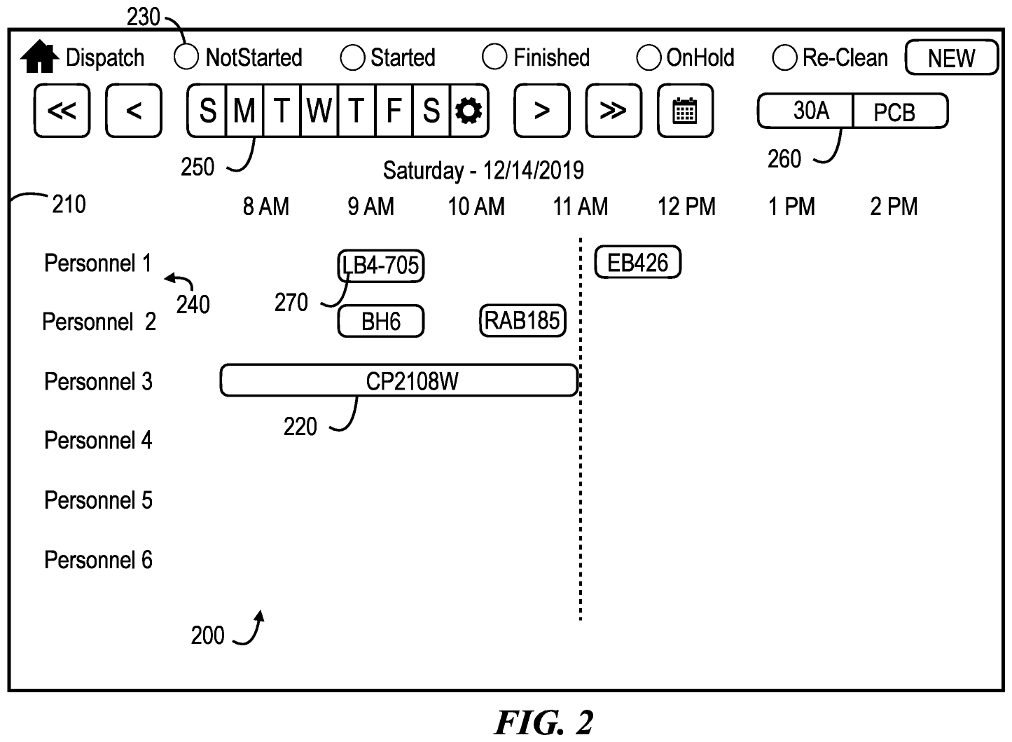

In reference to FIG. 2, an exemplary screenshot of the status interface 200 comprising a calendar portion 210 having a plurality of indicators 220, each of the plurality of indicators provided on a timeline to indicate the status of a housekeeper or inspector at a specific time (such as for a single day, hours of a day, minutes of an hour, or other time period) is shown. The indicators 220 may be color coded to indicate the status of the housekeeper or inspector. For example, the indicator 220 may be colored green to indicate that the housekeeper or inspector checked-in to a property and completed various tasks at a specific time (such as 9 AM). The color red may indicate that the housekeeper or inspector has not checked-in to the property. Color coding the indicator 220 provides a means for easily determining the status of various rental properties for a specific day. The indicator 220 may be selectable to view additional details for the property. An indicator key 230 provides a color-coded reference for each indicator 220 displayed on the status interface 200. The calendar portion 210 displays a plurality of personnel 240 to permit a user to monitor each of the plurality of personnel 240 over a period of time. A time selector 250 permits the user to change the period of time (such as the day, time of day, week, month, or other time interval) to allow the user to view a specified period of time on the calendar portion 210 of the interface. One or more location indicators 260, which allow the user to select a location of properties to be displayed on the calendar portion 210, may be used.

As used herein, the term “personnel” may refer to housekeepers, inspectors, maintenance personnel, or other personnel who perform tasks related to the property.

In some embodiments, each indicator 220 comprises an identifier 270 (as shown in FIG. 2) to display a property name to the user.

In some embodiments, the indicator key is comprised of a red indicator to indicate a property cleaning has not been started or that the property must be recleaned, an orange indicator to indicate the personnel have checked in to the property and the cleaning has started, a green indicator to indicate the cleaning is finished, a blue indicator to indicate the cleaning is on hold.

In some embodiments, a plurality of colors may be used when color coding the indicator. For example, the color orange may be used to indicate that the housekeeper has checked-in and is currently performing various tasks to prepare the property for a future rental.

In some embodiments, an interface is provided for managing auxiliary personnel such as maintenance personnel, etc. The interface may also provide a means for managing other aspects of the rental, such as payment processing and scheduling.

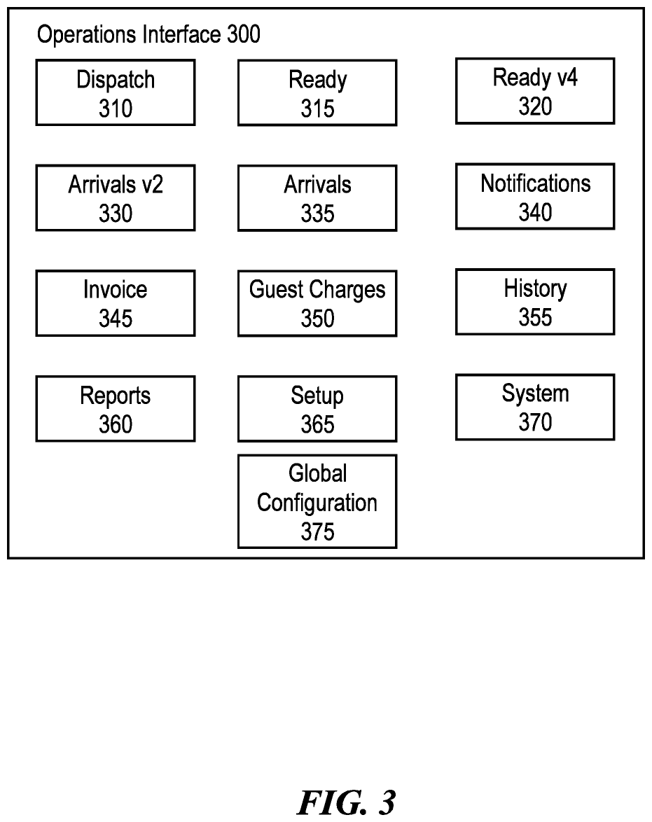

FIG. 3 illustrates a block diagram of the operations interface 300 and a plurality of functions available for the user to engage with from the operations interface 300. A dispatch tab 310 allows the user to view the calendar interface illustrates in FIG. 2. The ready tab 315 and ready v4 tab 320 display a listing of properties which are currently ready for tenants to move in. The arrivals tab 330 and arrivals v2 tab 335 display a listing of properties which have a scheduled arrival of a tenant. A notifications tab 340 provides a notification interface which allows the user to view notifications sent by the system. An invoice tab 345 allows the user to view, generate, and send invoices to tenants, contractors, maintenance personnel, or other users and systems connected to the system. A guest charges tab 350 allows the user to charge guests for various billable goods and services at the property. A history tab 355 allows the user to view a history of various features of the system, such as the property history, personnel history, tenant history, etc., while a reports tab 360 generates reports for various features of the system. A setup tab 365, system tab 370, and global configuration tab 375 allow the user to setup and configure various features of the system.

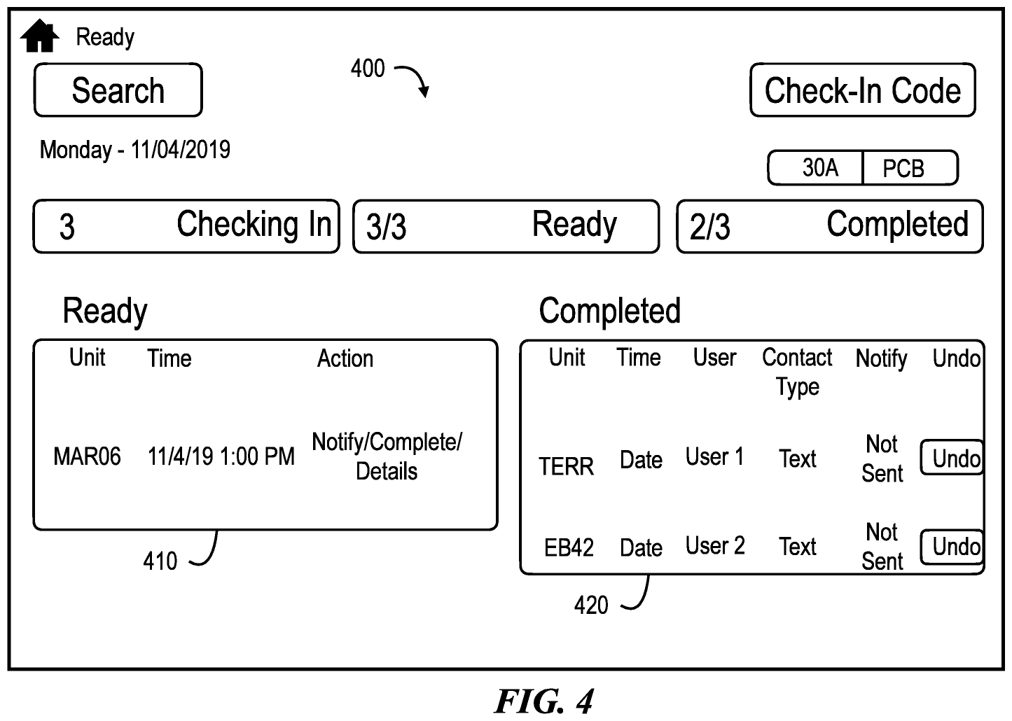

FIG. 4 illustrates the ready interface 400 which permits the user to view properties that are ready (via a ready portion 410) and properties at which cleaning is completed (via a completed portion 420. The user may also view how may properties are checked-in by maintenance personnel or tenants, how many properties are ready of available properties for a particular day, and how many properties have been completed for a particular day. The ready interface displays the aforementioned information for a particular day, or likewise period of time. The ready interface may also provide a means for contacting the tenant with check-in instructions for the property they have reserved.

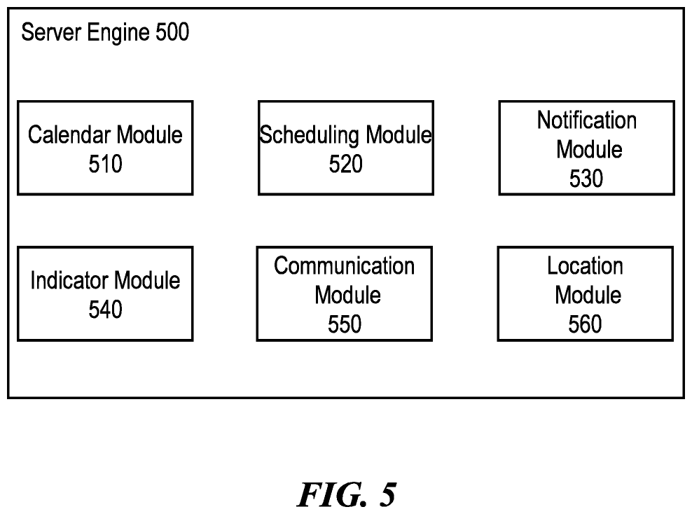

FIG. 5 illustrates a server engine 500 comprising a plurality of modules. A calendar module 510 generates the calendar displayed on the calendar interface while a scheduling module 520 schedules personnel for particular properties at a particular time. The scheduling module 520 ensures that no conflicts are scheduled for each personnel. A notification module 530 generates notifications to various users of the system. An indicator module 540 generates indicators for the status of each property and personnel associated thereto to change the indicator as described above. A communication module 550 allows users of the system to communicate with one another, such as by sending alerts, sending check-in information, or likewise communications known in the arts. A location module 560 identifies a location of each property.

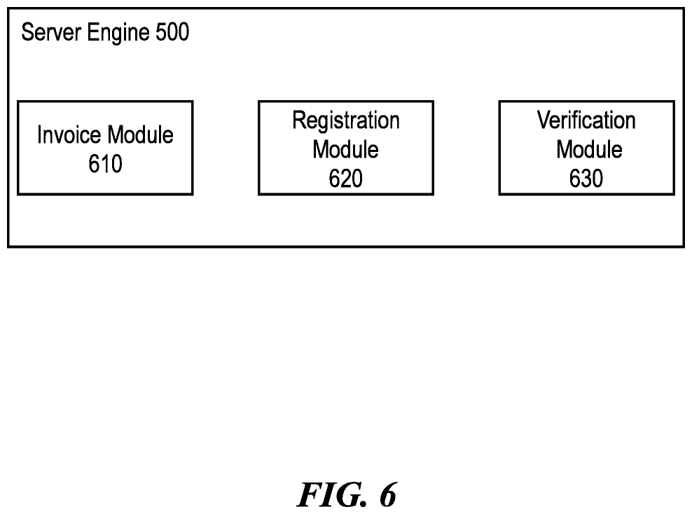

FIG. 6 illustrates the server engine 500 and associated modules. An invoice module 610 permits the generations and transmission of invoices to various users of the system. The invoice module 610 may be in communication with a payment processing system to facilitate the transfer of payments. A registration module 620 permits the user to register within the system, such as by registering as a user type (such as a property manager, administrator, cleaning personnel, maintenance personnel, tenant, etc.). A verification module 630 verifies user credentials, such as log-in information.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for managing a rental property, the system comprising:
a computing device in operable communication with a database to store information related to a plurality of rental properties; and
a calendar module to receive scheduling information via the computing device, the scheduling information including a date and a time of a service, the scheduling information corresponding to a plurality of rental properties and a plurality of housekeepers, the calendar module to organize the scheduling information on a status interface comprising a plurality of indicators to indicate the status of the plurality of housekeepers, and each of the plurality of indicators provided on a timeline corresponding to the date and the time of the service.

2. The system of claim 1, wherein the plurality of indicators are color coded.

3. The system of claim 1, further comprising a payment processing system.

4. The system of claim 1, further comprising a maintenance personnel interface.

5. The system of claim 1, further comprising a communication module to permit communication between users and tenants.

6. A system for managing a rental property, the system comprising:
a computing device in operable communication with a database to store information related to a plurality of rental properties;
a calendar module to receive scheduling information via the computing device, the scheduling information corresponding to a plurality of rental properties and a plurality of housekeepers, the calendar module to organize the scheduling information on a calendar interface comprising at least a date and a plurality of times provided on a timeline;
a plurality of indicators to indicate the status of the plurality of housekeepers in real-time, the plurality of indicators positioned on a calendar portion of the status interface.
an indicator module to display an indicator on a display of the computing device to indicate the status of the plurality of rental properties on the calendar portion of the status interface; and
a communication module to permit the communication between one or more users.

7. The system of claim 6, further comprising an invoice module to permit the generation and transmission of an invoice.

8. The system of claim 7, further comprising a ready interface to indicate properties which are ready for rental during a period of time.

9. The system of claim 8, wherein the communication module transmits check-in information corresponding to a rental property to the tenants.

10. The system of claim 9, further comprising a scheduling module to facilitate scheduling of the plurality of housekeepers.

11. The system of claim 6, wherein the plurality of indicators are color coded.

12. The system of claim 6, further comprising a maintenance personnel interface.

13. A system for managing a rental property, the system comprising:
a computing device in operable communication with a database to store information related to a plurality of rental properties;
a calendar module to receive scheduling information via the computing device, the scheduling information corresponding to a plurality of rental properties and a plurality of housekeepers, the calendar module to organize the scheduling information on a status interface comprising at least a date and a plurality of times provided on a timeline and a plurality of color coded indicators to indicate the status of the plurality of housekeepers in real-time;
an indicator module to display an indicator on a display of the computing device to indicate the status of the plurality of rental properties on the calendar portion of the status interface;
a location module to determine the location of each of the plurality of rental properties;
and
a communication module to permit the communication between one or more users.

14. The system of claim 13, wherein each of the plurality of color coded indicators comprises an identifier to identify at least one of the plurality of rental properties.

15. The system of claim 14, wherein the plurality of color coded indicators comprise at least one of the following: a not started indicator, a started indicator, a finished indicator, an on hold indicator, and a re-clean indicator.

16. The system of claim 15, further comprising an invoice module to permit the generation and transmission of an invoice.

17. The system of claim 16, further comprising a ready interface to indicate properties which are ready for rental during a period of time.

18. The system of claim 17, wherein the communication module transmits check-in information corresponding to a rental property.

19. The system of claim 18, further comprising a scheduling module to facilitate scheduling of the plurality of housekeepers.

20. The system of claim 19, further comprising a maintenance personnel interface to permit scheduling of maintenance personnel.
